(19) United States
(12) Patent Application Publication
(10) Pub. No.: US 2026/0037939 A1
(43) Pub. Date: Feb. 5, 2026

(54) METHOD FOR PROCESSING FINANCIAL TRANSACTION

(71) Applicant: Glory Ltd., Himeji-shi (JP)

(72) Inventor: Shimpei NISHIDA, Himeji-shi, Hyogo (JP)

(73) Assignee: Glory Ltd., Himeji-shi (JP)

(21) Appl. No.: 19/289,157

(22) Filed: Aug. 4, 2025

(30) Foreign Application Priority Data
Aug. 5, 2024 (JP) 2024-128636

(51) Int. Cl. G06Q 20/10; G06Q 10/0835; G06Q 10/0836

(52) U.S. Cl. CPC G06Q 20/10; G06Q 10/0835; G06Q 10/08365

(57) ABSTRACT

A method of processing a financial transaction includes: acquiring, by a second terminal used by a store, first information related to a reservation of a financial transaction accepted by a first terminal; acquiring, by the second terminal, second information related to a payment for a product or service by a user who reserved the financial transaction; and performing, by the second terminal, a cash transaction based on the first information on the reservation when executing a payment process based on the second information.

### CROSS-REFERENCE TO RELATED APPLICATION

This application claims priority to Japanese Patent Application No. 2024-128636 filed on Aug. 5, 2024, the entire disclosure of which is incorporated herein by reference.

### BACKGROUND

Conventional vending machines provide financial service to a user in addition to product service. When the user selects the product service, the vending machine processes a payment in cash fed or by a card inserted and provides the product to the user. When the user selects the financial service, the vending machine accesses a transaction institution via the Internet and provides service such as account transfer, credit card inquiry, charging to a prepaid card by money transfer, balance confirmation of the prepaid card, and bonus point confirmation.

### SUMMARY

The technology disclosed herein relates to a method of processing a financial transaction. The method includes: acquiring, by a second terminal used by a store, first information related to a reservation of a financial transaction accepted by a first terminal; acquiring, by the second terminal, second information related to a payment for a product or service by a user who reserved the financial transaction; and performing, by the second terminal, a cash transaction based on the first information on the reservation in a case where a payment process is executed based on the second information.

### BRIEF DESCRIPTION OF THE DRAWINGS

FIG. 1 illustrates a financial transaction system.

FIG. 2 is a block diagram showing a configuration of a register.

FIG. 3 is a flowchart of processing steps performed by the financial transaction system.

FIG. 4 shows a financial transaction system according to a variation.

FIG. 5 is a flowchart of processing steps performed by the financial transaction system according to the variation.

FIG. 6 shows a locker provided with a self-checkout register and a money handling apparatus.

FIG. 7 shows a financial transaction system according to a variation.

FIG. 8 is a flowchart of processing steps performed by the financial transaction system according to the variation.

### DETAILED DESCRIPTION OF THE DRAWINGS

A user who makes a financial transaction involving handling of cash visits a store of a financial institution or uses an automated teller machine (ATM) or a cash dispenser (CD) placed in various places.

For example, if a financial transaction involving handling of cash is possible when a payment process for a product that the user purchases or service that the user receives is executed at a store, user convenience is enhanced.

A so-called cashout service is typically an optional service that can be selected at the time of payment by a debit card or a credit card. The cashout service is a limited service available in a specific payment method. There is room for user convenience in performing financial transactions.

The technology disclosed herein makes the financial transactions more convenient for users.

The technology disclosed herein relates to a method of processing a financial transaction. The method includes: acquiring, by a second terminal used by a store, first information related to a reservation of a financial transaction accepted by a first terminal; acquiring, by the second terminal, second information related to a payment for a product or service by a user who reserved the financial transaction; and performing, by the second terminal, a cash transaction based on the first information on the reservation in a case where a payment process is executed based on the second information.

Here, the term “store” is not limited to so-called commercial facilities, and broadly includes places related to the sale of products or provision of service. The store may be an entity that sells products or provides service. The store may not be an entity that sells products or provides service. The store may be, for example, a store that delivers a product purchased by the user in a different store or an electronic commerce site to the user, or a store that delivers an item derived from service provided by a different store or an electronic commerce site to the user. Examples of the item derived from the service include user's clothing cleaned by cleaning service, photographs printed by photograph printing service, and devices rented to the user by rental service.

The “second terminal used by the store” includes a terminal owned by the store, a terminal managed by the store, or a terminal used by the store. The second terminal may be or may not be installed in a store.

The user makes a reservation of a financial transaction using the first terminal. The first terminal may be a terminal used by the user. The first terminal may be a terminal owned by the user. The first terminal has a communication function of transmitting and receiving information via a communication line, for example. The first terminal is, for example, a smartphone. The first terminal is, for example, a personal computer (PC). The PC includes tablet PCs. The first terminal accepts a reservation of a financial transaction.

The second terminal acquires the first information. The first information is information related to the reservation of the financial transaction. The second terminal acquires the first information via, for example, a communication line. The second terminal may acquire the first information from the first terminal directly or via a server.

The second terminal acquires the second information. The second information is information related to a payment for a product or service. The product or the service is a product that the user purchases or service that the user receives. For example, when the user visits a store and purchases a product, the second information is information of the price of the product.

The user makes a payment based on the second information. The second terminal executes a payment process based on the second information. The payment process may be executed by any means. For example, the user may make the payment in cash or by electronic money, a credit card, or a debit card. The second terminal also performs a cash transaction based on the first information on the reservation when executing the payment process based on the second information. The payment process based on the second information and the cash transaction based on the first information are not limited to be performed simultaneously in a strict sense, and are performed substantially simultaneously. The user does not need to visit both the store selling the product and another item and the store of the financial institution. In addition, the user can make a cash transaction related to the reserved financial transaction at the same time as the payment for the product or service. This increases user convenience.

The second terminal may be connected to a money handling apparatus that handles cash. The method may further include causing, by the second terminal, the money handling apparatus to handle cash in a case where the cash transaction is performed based on the first information.

In a case where the cash transaction is a cash withdrawal, the user can receive cash withdrawn from the account and dispensed by the money handling apparatus. In a case where the cash transaction is a cash deposit, the user can deposit cash to the account by feeding the cash into the money handling apparatus.

The second information may be information about a payment for a product or service provided by the store.

The second information may be information about a payment for a product or service provided by a second store different from the store. In this case, the store (i.e., the first store) functions as a window for executing a payment for the product or service provided to the user by the second store. The first store may also deliver the product provided by the second store or an item derived from service provided by the second store to the user.

The product or an item derived from the service may be provided to the user via a locker. The method may further include the locker being unlocked in conjunction with the execution of the payment process based on the second information by the second terminal.

Use of the locker allows the product or the item derived from the service to be provided to the user without staff.

The method may further include performing, by the second terminal, the cash transaction based on the first information and the payment process based on the second information individually or collectively.

In a case where the withdrawal and the payment as the cash transactions are individually performed, a reserved amount of cash is dispensed to the user, and the user pays for the product and another item at the face value. In a case where the withdrawal and the payment are collectively performed, cash of the difference between the price of the product and another item and the reserved withdrawal amount may be dispensed to the user. In a case where the deposit and the payment are collectively performed, cash of the difference between the price of the product and another item and the reserved deposit amount may be deposited to the account of the user.

The method may further include: accepting, by the first terminal, a reservation of the product or the service in addition to the reservation of the financial transaction; and creating, by the second terminal, the second information including information on the reservation of the product or the service and information on the payment for the product or the service based on the reservation of the product or the service accepted by the first terminal.

That is, the user can reserve the product that the user plans to purchase or the service that the user wishes to receive, together with the reservation of the financial transaction. Offering the reservation of the product and another item improves the user convenience.

The second terminal creates the second information including information on the reservation of the product or the service and information on the payment for the product or the service. For example, the user who made the reservation visits the store and receives the reserved product or service (including reception of an item derived from the service). The user also makes the payment for the product or the service and a cash transaction associated with the reserved financial transaction at the store.

The method may further include outputting, by the second terminal, a command related to the delivery of cash withdrawn based on the first information, and the product or an item derived from the service, to a third terminal used for the execution of the delivery.

In a case where the user makes a reservation of a product or service, the store may deliver the reserved product or an item derived from the reserved service and cash withdrawn by the reserved financial transaction to a delivery destination specified by the user.

The method may further include outputting, by the second terminal, a command including a first delivery destination of the cash and a second delivery destination of the product or the item to the third terminal.

For example, the user may set the user's home as the delivery destination of the cash, and a place other than the user's home, such as a hospital or any other places, as the delivery destination of the product or item other than the cash.

The third terminal may be carried by a delivery person in charge of the delivery, or may be mounted on an autonomous mobile object in charge of the delivery.

The delivery person can perform the delivery using the third terminal. The autonomous mobile object can perform the delivery using the third terminal. The autonomous mobile object may be, for example, an autonomous mobile robot (AMR) or an autonomous drone.

The method may further include: transmitting, by the first terminal, the first information to a financial server; and acquiring, by the second terminal, the first information via the financial server.

The store may be a distributor store. The method may further include: transmitting, by the first terminal, the first information to the financial server, and a reservation of the product or the service to a distribution server; and acquiring, by the second terminal, the first information via the financial server, and information on the reservation of the product or the service via the distribution server. A distributor store may be a broader concept and may be, for example, a retail store. Similarly, a distribution server may be a broader concept and may be, for example, a retail server.

The financial server and the distribution server may be included in a single server.

The method may further include performing, by the second terminal, a withdrawal transaction that is the cash transaction, in conjunction with the payment process.

An embodiment of a financial transaction processing method will be described below with reference to the drawings. The financial transaction processing method described herein is exemplary.

### (General Configuration of Financial Transaction System)

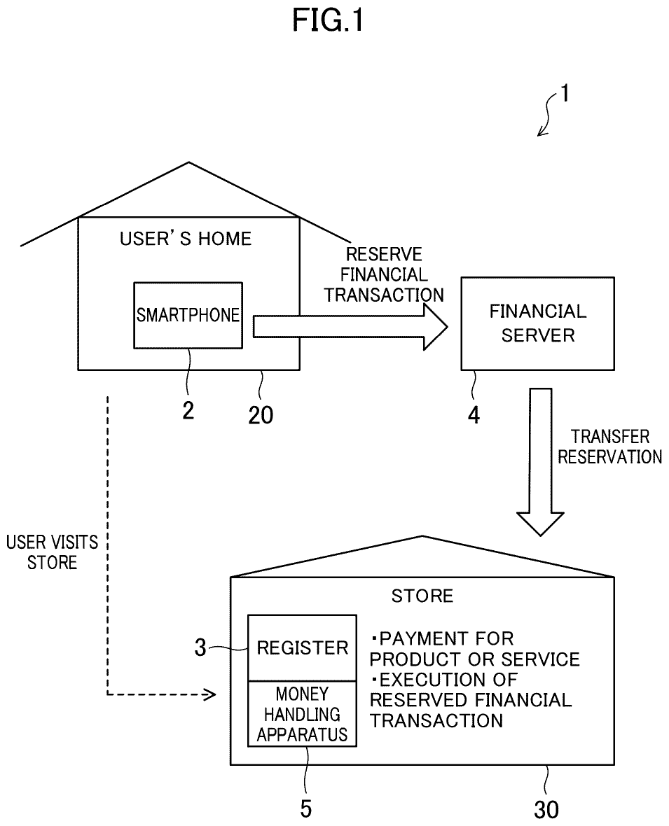

FIG. 1 shows a general configuration of a financial transaction system 1. The financial transaction system 1 is a system that allows easy execution of a financial transaction desired by a user and enhances user convenience.

A user who uses the financial transaction system 1 uses the first terminal. The first terminal is, for example, a smartphone 2. The smartphone 2 is not limited to the smartphone 2 owned by the user, and may be any smartphone 2 handled by the user. The smartphone 2 is a portable device. Although the smartphone 2 is located inside a user's home 20 in FIG. 1, the user can use the smartphone 2 at any location. The smartphone 2 has at least (1) an input function that is user-operable, (2) a communication function of transmitting and receiving information via a communication line in accordance with the operation of the user, and (3) an output function of visually or aurally providing information to the user. The communication line is a wide area communication line (including the Internet).

The first terminal used by the user is not limited to the smartphone 2. The first terminal may be any terminal that can achieve the functions (1), (2), and (3) described above. The first terminal may be, for example, a PC. The first terminal may be, for example, a tablet PC.

The financial transaction system 1 includes a second terminal. The second terminal is a terminal used by a store 30. In the example shown in FIG. 1, the second terminal is a register (i.e., a cash register) 3 placed in the store 30. The store 30 is a distributor store in this example. The store 30 in the financial transaction system 1 is not limited to a so-called commercial facility, and broadly includes places related to the sale of products or provision of services.

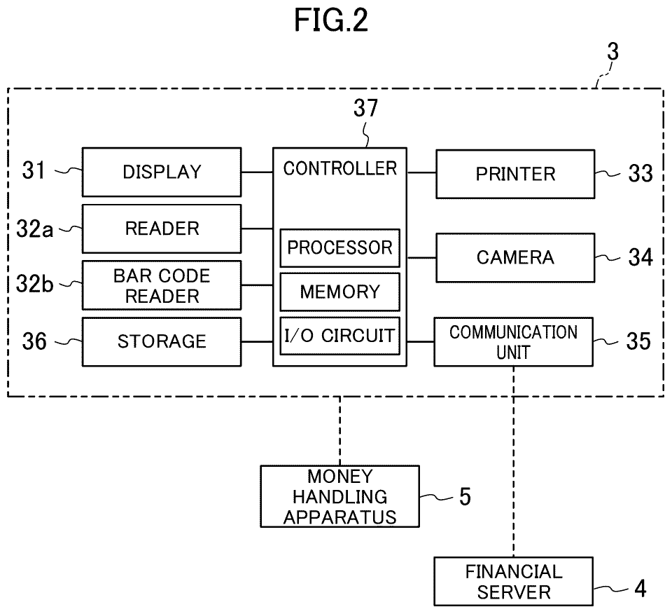

FIG. 2 is a block diagram showing the configuration of the register 3. The register 3 executes a payment for a product or a service. The register 3 includes both a so-called manned register operated by a staff member of the store 30 and a so-called self-checkout register operated by a user of the store 30.

The register 3 has a display 31. The display 31 is, for example, a touchscreen. The display 31 provides visual information to the operator of the register 3. The operator can also operate the register 3 using the display 31.

The register 3 includes a reader 32a and a bar code reader 32b. The payment process by the register 3 includes a payment in cash. The payment process by the register 3 includes a payment by electronic money, a credit card, or a debit card, in addition to the payment in cash. The reader 32a reads information about the electronic money, the credit card, or the debit card. The bar code reader 32b acquires identification information (bar code) about a product that the user purchases or the service offered to the user, and a controller 37 acquires price information of the product or the service. The bar code reader 32b may acquire identification information and the like of the staff member.

The register 3 has a printer 33. The printer 33 prints a receipt of the payment processed by the register 3. The register 3 includes a camera 34. The camera 34 is used to read a code that is shown on the display of the smartphone 2 and related to the reserved financial transaction, as will be described later.

The register 3 is connected to a money handling apparatus 5. The money handling apparatus 5 handles cash. The cash includes at least one of banknotes or coins. The money handling apparatus 5 executes, based on an instruction signal from the register 3, a deposit process of storing cash in the money handling apparatus 5 and a withdrawal process of dispensing the stored cash out of the money handling apparatus 5. The deposit process includes a process of storing cash paid by the user for the payment in the money handling apparatus 5. The withdrawal process includes a process of dispensing cash from the money handling apparatus 5 as change for the payment returned to the user. Although details will be described later, the money handling apparatus 5 handles cash related to a financial transaction reserved by the user, in addition to the deposit and withdrawal processes associated with the payment process.

The register 3 includes a communication unit 35. The register 3 can communicate with a financial server 4 which will be described later via the communication unit 35. The register 3 acquires information on the financial transaction reserved by the user from the financial server 4 via a communication line. The communication line is a wide area communication line (including the Internet), and the communication unit 35 is an interface corresponding to the wide area communication line. The register 3 may acquire information from the financial server 4 via a server of the store 30 interposed between the register 3 and the financial server 4, instead of directly acquiring information from the financial server 4.

The register 3 includes a storage 36. The storage 36 stores various types of information necessary for the operation of the register 3. The storage 36 stores information about the financial transaction reserved by the user.

The register 3 includes a controller 37. The controller 37 includes at least a processor, memory, and an I/O circuit. The processor executes programs. The memory stores programs and data for the operation of the register 3. The memory is, for example, random access memory (RAM) and/or read only memory (ROM). The I/O circuit inputs and outputs electrical signals between the controller 37 and a device connected to the controller 37. The controller 37 outputs a control signal to the device to operate the register 3.

The financial server 4 is a server operated by a financial institution, for example, a bank. The financial server 4 is, for example, a server that provides Internet banking services to a user. The financial server 4 includes at least a processor, memory, a storage, and a network interface. A user who has an account in the financial institution can use the Internet banking services using the smartphone 2. The Internet banking services do not allow the user to make a cash transaction such as cash withdrawal from the account, that is, a withdrawal transaction, or cash deposit to the account, that is, a deposit transaction.

The financial server 4 provides a new service that is previously unavailable and allows the user to make a cash transaction. This service enables a user to make a cash transaction using the register 3 and the money handling apparatus 5 at the store 30 for a financial transaction that the user reserved using the smartphone 2. More specifically, in the financial transaction system 1, the user can reserve, for example, a cash withdrawal or deposit transaction for the user's own account, to the financial server 4 using the smartphone 2. The financial transaction system 1 executes the reserved cash withdrawal or deposit transaction at the store 30 specified by the user. The user who visits the store 30 can receive the withdrawn cash or deposit cash.

In the financial transaction system 1, not only the reserved financial transaction is performed at the store 30, but also the payment process is performed at the same time at the store 30. The user can make the reserved financial transaction when doing shopping and the like at the store 30 without going to the financial institution. This increases user convenience.

### (Processing Steps of Financial Transaction System)

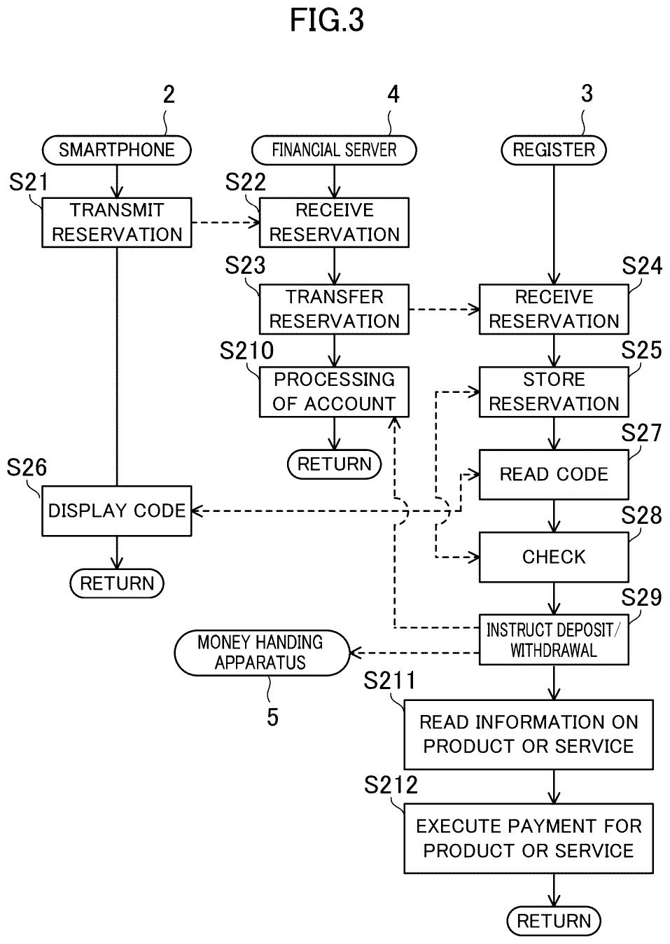

Processing steps of the financial transaction system 1 will be described below with reference to FIGS. 1 and 3. First, the user makes a reservation for a financial transaction using the smartphone 2. The reservation of the financial transaction includes at least (1) information on the type of the financial transaction desired by the user, for example, whether the transaction is a cash withdrawal or a cash deposit, (2) the withdrawal or deposit amount, and (3) information on the store 30 at which the user wishes to make the cash transaction. The user may specify, for example, the store 30 at which the user wishes to purchase a product or receive service. When the user operates the smartphone 2 to input these pieces of information, the smartphone 2 transmits reservation information to the financial server 4 (see Step S21).

The financial server 4 receives the reservation from the smartphone 2 in Step S22. The financial server 4 transfers the reservation information to the register 3 of the store 30 where the financial transaction is to be executed, based on the reservation information (see Step S23). The financial server 4 stores the financial information until the financial transaction is executed.

The register 3 of the store 30 receives the reservation from the financial server 4 in Step S24, and stores the received reservation in the storage 36 in Step S25. The processes of Steps S21 to S25 are related to the reservation of a financial transaction by the user.

The user who reserved the financial transaction goes to the specified store 30 as indicated by a broken line arrow in FIG. 1. The user purchases the product or receives the service at the store 30. The register 3 of the store 30 processes the payment for the product or the service. The user also operates the smartphone 2 to show a code related to the reserved financial transaction on the display of the smartphone 2 (see Step S26 in FIG. 3). The code may be a bar code or a two-dimensional code. The code on the display is read by the camera 34 of the register 3 (see Step S27). The register 3 checks the read code against the stored reservation information in Step S28.

If the code matches the reservation information in Step S29, the register 3 instructs the money handling apparatus 5 to execute the process related to the reserved financial transaction. That is, if the reserved financial transaction is a cash withdrawal, the register 3 instructs the money handling apparatus 5 to dispense cash. If the reserved financial transaction is a cash deposit, the register 3 instructs the money handling apparatus 5 to deposit cash received from the user. The register 3 also reports to the financial server 4 that the cash transaction is executed when instructing the cash deposit/withdrawal to the money handling apparatus 5. In Step S210, the financial server 4 records the withdrawal or deposit transaction for the user's account corresponding to the executed cash transaction.

In Step S211, the register 3 reads information on the product or the service. Using the bar code reader 32b, the controller 37 acquires product or service price information by acquiring the identification information (bar code) related to the product that the user purchases or the service provided to the user. The process of Step S211, which is performed after Step S29 in the example shown in FIG. 3, may be performed before Step S27, S28, or S29.

The register 3 also executes a payment process for the product or the service in Step S212.

Assume that the user reserves a withdrawal transaction of 10,000 yen and purchases a product of 3,000 yen at the store 30. The user pays 3,000 yen for the product. Further, the user receives 10,000 yen dispensed by the money handling apparatus 5. That is, the financial transaction and the payment process are performed individually. The money handling apparatus 5 dispenses 10,000 yen in the process of Step S29, and then 3,000 yen, which is the payment amount of the product, is paid in the process of Step S212.

In the flowchart of FIG. 3, the financial transaction and the payment process are individually performed, but the register 3 may collectively perform the financial transaction and the payment process. As described above, when the user reserves a withdrawal transaction of 10,000 yen and purchases a product of 3,000 yen at the store 30, the register 3 may instruct the money handling apparatus 5 to dispense 7,000 yen, which is the difference between the price of the product and the amount of the reserved financial transaction. The user receives 7,000 yen dispensed by the money handling apparatus 5. In this case, the processes of Steps S29 and S212 are performed substantially at the same time. If the financial transaction and the payment process are collectively performed, the process of Step S211 is performed before Step S29.

Whether to perform the financial transaction and the payment process individually or collectively may be specified in advance by the user when making a reservation for the financial transaction, or may be specified by the user when executing the payment process with the register 3.

Assume that the user reserves a deposit transaction of 10,000 yen and purchases a product of 3,000 yen at the store 30. The user pays 3,000 yen for the product and feeds 10,000 yen for the deposit transaction into the money handling apparatus 5. That is, the financial transaction and the payment process are performed individually, and 10,000 yen is fed to the money handling apparatus 5 in the process of Step S29, and then 3,000 yen, which is the payment amount of the product, is paid in the process of Step S212.

When the deposit transaction of 10,000 yen and the payment of 3,000 yen are collectively performed, the register 3 may report to the financial server 4 that the cash transaction is executed in which 10,000 yen for the deposit transaction is fed to the money handling apparatus 5 and 7,000 yen which is the difference between 10,000 yen and 3,000 yen paid for the product is added (that is, deposited) into the account of the user. In this case, the processes of Steps S29 and S212 are performed substantially at the same time. If the financial transaction and the payment process are collectively performed, the process of Step S211 is performed before Step S29.

When the user makes a reservation using a PC without using the smartphone 2, the user may print the code on a piece of paper at the reservation and bring the paper on which the code is printed to the store 30.

Alternatively, a reservation number may be used instead of the code to identify the financial transaction. The financial server 4 issues the reservation number when the user reserves the financial transaction, and provides the reservation number to the smartphone 2. When the reservation number is inputted to the touchscreen (display 31) of the register 3 in Step S27, the register 3 checks the reservation number against the stored reservation in Step S28.

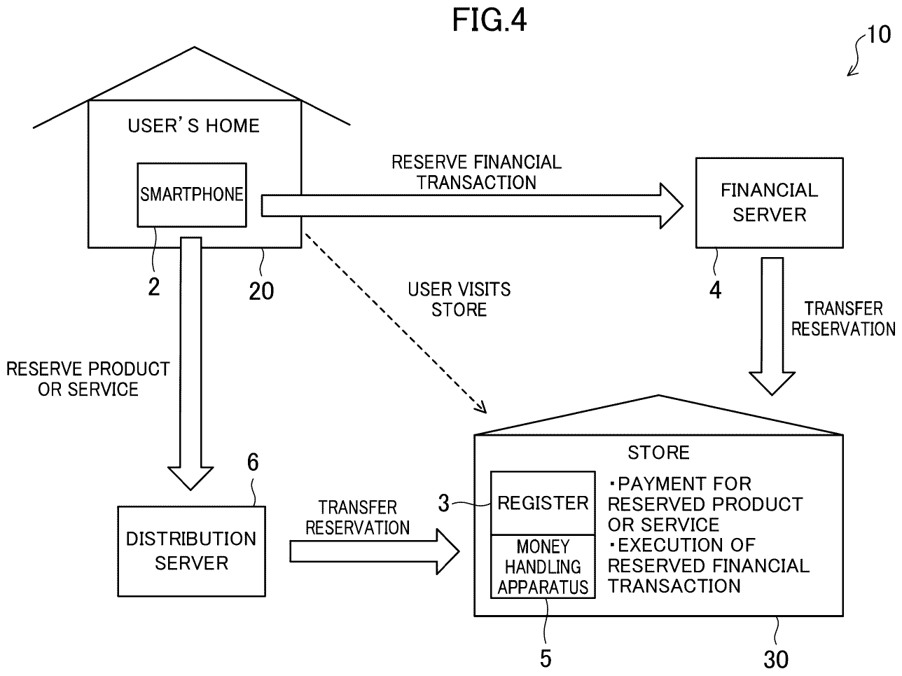

(Example of Financial Transaction System Allowing Product or Service Reservation) FIG. 4 shows a variation of the financial transaction system. A financial transaction system 10 shown in FIG. 4 is different from the financial transaction system 1 in FIG. 1 in that a distribution server 6 is added. The user can reserve a product to be purchased or service to be provided at the store 30 in the financial transaction system 10. The user reserves a financial transaction and reserves a product or service using the smartphone 2. The distribution server 6 is a server that manages the reservation for the product and another item. The distribution server 6 includes at least a processor, memory, a storage, and a network interface. The distribution server 6 has a function of communicating with the smartphone 2 via a communication line. For example, a server that operates an electronic commerce site can be used as the distribution server 6.

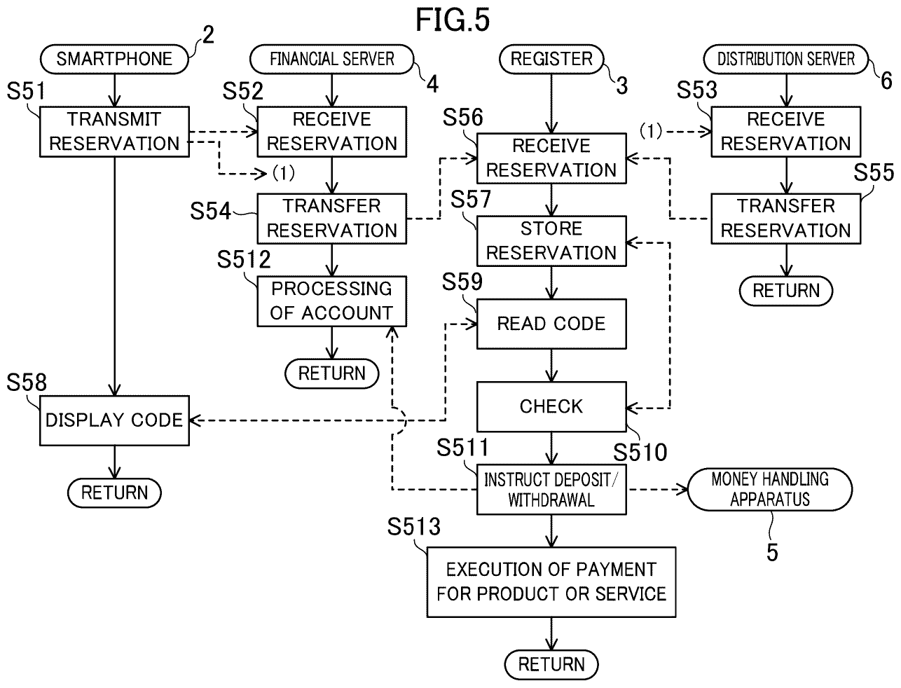

Processing steps of the financial transaction system 10 will be described below with reference to FIGS. 4 and 5. First, the user reserves a financial transaction and reserves a product or service using the smartphone 2 in Step S51. As described above, the reservation of the financial transaction includes at least (1) information on the type of the financial transaction desired by the user (i.e., whether the transaction is a withdrawal or a deposit), (2) the withdrawal or deposit amount, and (3) information on the store 30 at which the user wishes to make the cash transaction. The reservation of the product or the service includes at least specification of the product that the user plans to purchase or the service that the user wishes to receive and information on the store 30 at which the user receives the product or the service. The specification of the service desired by the user may include, for example, a reservation of time when the service is provided. Examples of the provision of the service include reception of user's clothing cleaned by cleaning service, reception of photographs printed by photograph printing service, and reception of devices rented to the user by rental service. The clothing, the photographs, or the devices are examples of the item derived from the service. In the photograph printing service, data of photographs to be printed may be transmitted from the smartphone 2 to the distribution server 6.

The user specifies the store 30 related to the product or the service and the store 30 related to the financial transaction as the same store.

The financial server 4 receives the reservation of the financial transaction from the smartphone 2 in Step S52. The distribution server 6 receives the reservation of a product or service from the smartphone 2 in Step S53. The financial server 4 transfers the reservation information to the register 3 of the store 30 where the financial transaction is executed based on the reservation information in Step S54. The distribution server 6 transfers the reservation information to the register 3 of the store 30 where the user receives the product or the service based on the reservation information in Step S55.

The register 3 of the store 30 receives the reservation from the financial server 4 and the reservation from the distribution server 6 in Step S56, and stores the received pieces of information on the financial transaction and the product or the service in Step S57. The processes of Steps S51 to S57 are related to the reservation by the user. The reserved product or service is prepared as necessary at the store 30.

The user goes to the specified store 30 as indicated by a broken line arrow in FIG. 4. The user operates the smartphone 2 to show the code associated with the reserved financial transaction on the display of the smartphone 2 (see Step S58). The code on the display is read by the camera 34 of the register 3 (see Step S59). The register 3 checks the read code against the stored information in Step S510.

If the code matches the information on the financial transaction, the register 3 instructs the money handling apparatus 5 to perform the process related to the reserved financial transaction (Step S511). That is, if the reserved financial transaction is a cash withdrawal, the register 3 instructs the money handling apparatus 5 to dispense cash. If the reserved financial transaction is a cash deposit, the register 3 instructs the money handling apparatus 5 to deposit cash received from the user. The register 3 also reports to the financial server 4 that the cash transaction is executed when instructing the cash deposit/withdrawal to the money handling apparatus 5. In Step S512, the financial server 4 records the withdrawal or deposit transaction for the user's account corresponding to the executed cash transaction.

The user receives the reserved product or service at the store 30, and the register 3 processes the payment for the product or the service in Step S513.

In the financial transaction system 10, the product or service related to the reservation is not limited to the product or service sold or provided by the store 30. For example, the user may reserve a product or service provided by a second store different from the store 30 and make a payment at the register 3 of the store 30. The product provided by the second store is delivered in advance from the second store to the store 30. The user makes a payment at the register 3 of the store 30 and receives the product. Examples of the service provided by the second store include the above-described cleaning service, photograph printing service, and device rental service. The user may make a payment at the register 3 of the store 30 and receive the item derived from these services at the store 30.

The user may receive the product purchased on an online shopping site at the store 30 by making a payment for the product at the register 3 of the store 30. The product can be prepared in the store 30 by delivering the product to the store 30 or by having the product as a stock in the store 30 (laying the product away in the store 30).

In the financial transaction system 10, the financial server 4 and the distribution server 6 may be integrated into a single server.

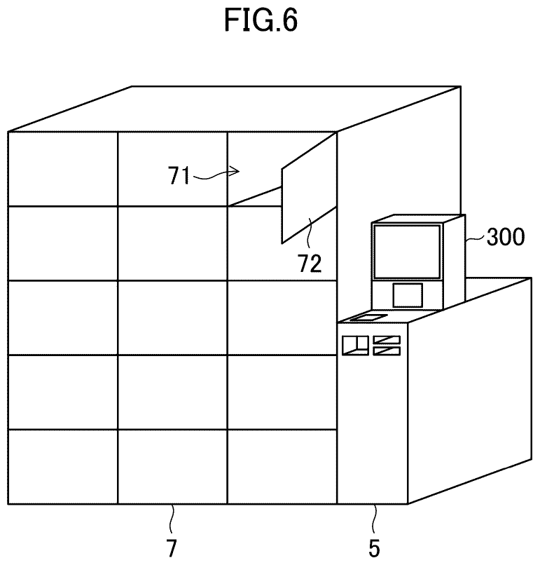

The financial transaction system 10 may include a locker with a self-checkout register. FIG. 6 illustrates a locker 7 with a self-checkout register 300. The locker 7 includes multiple storage spaces 71 and doors 72 that correspond to the respective storage spaces 71 and are locked and unlocked. The self-checkout register 300 outputs a command to unlock and lock the door 72 in conjunction with the payment process. The locker 7 with the self-checkout register 300 may be placed in the store 30 or various other facilities (e.g., at stations). The self-checkout register 300 may include the display 31, the reader 32a, the bar code reader 32b, the printer 33, the camera 34, the communication unit 35, the storage 36, and the controller 37, which are similar to those shown in FIG. 2.

As described above, each storage space 71 of the locker 7 stores the product reserved by the user for purchase or the item derived from the reserved service (such as cleaned clothing, printed photographs, and rented devices). The self-checkout register 300 unlocks the door 72 when the user makes a payment for the product or the service by operating the self-checkout register 300. The user may receive the product or the item. The self-checkout register 300 causes the money handling apparatus 5 to execute the cash transaction related to the reservation. Use of the locker 7 allows the store 30 to perform the payment process and the financial transaction without staff.

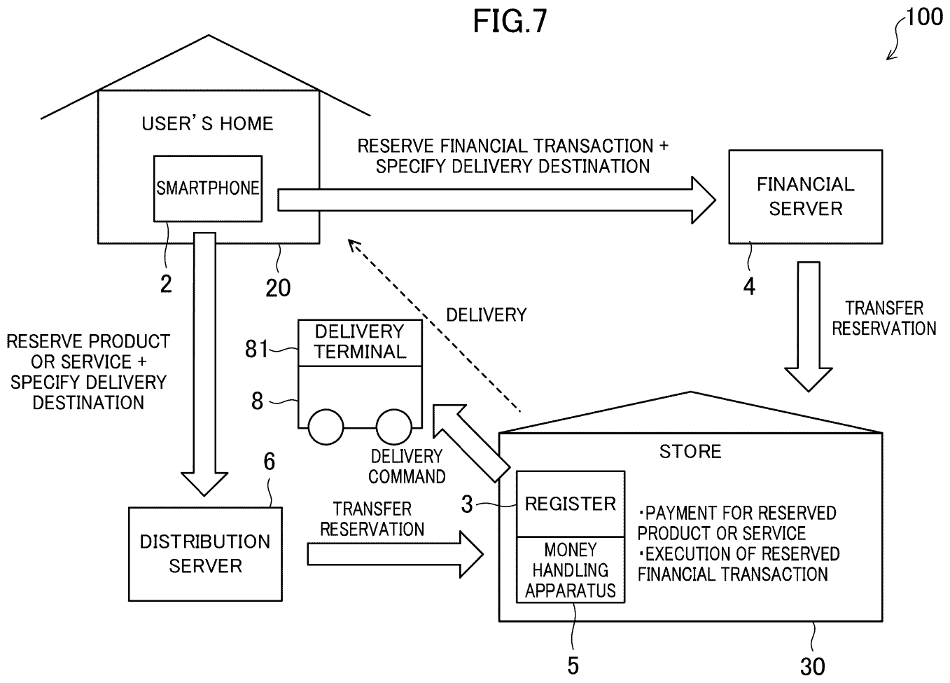

(Example of Financial Transaction System with Delivery of Product and Another Item) FIG. 7 shows a variation of the financial transaction system. A financial transaction system 100 shown in FIG. 7 is different from the financial transaction system 10 in FIG. 4 in that delivery service of products and other items is added.

The user can reserve a product to be purchased or service to be provided at the store 30 using the smartphone 2 as described above. When making the reservation, the user specifies a delivery destination of the product to be purchased or an item derived from the service to be purchased. The user also makes a reservation of a financial transaction and a delivery destination of cash associated with the financial transaction. The financial transaction in the financial transaction system 100 is mainly a cash withdrawal, which is made at the store 30 related to the purchase of the product or the provision of the service by a staff member of the store 30.

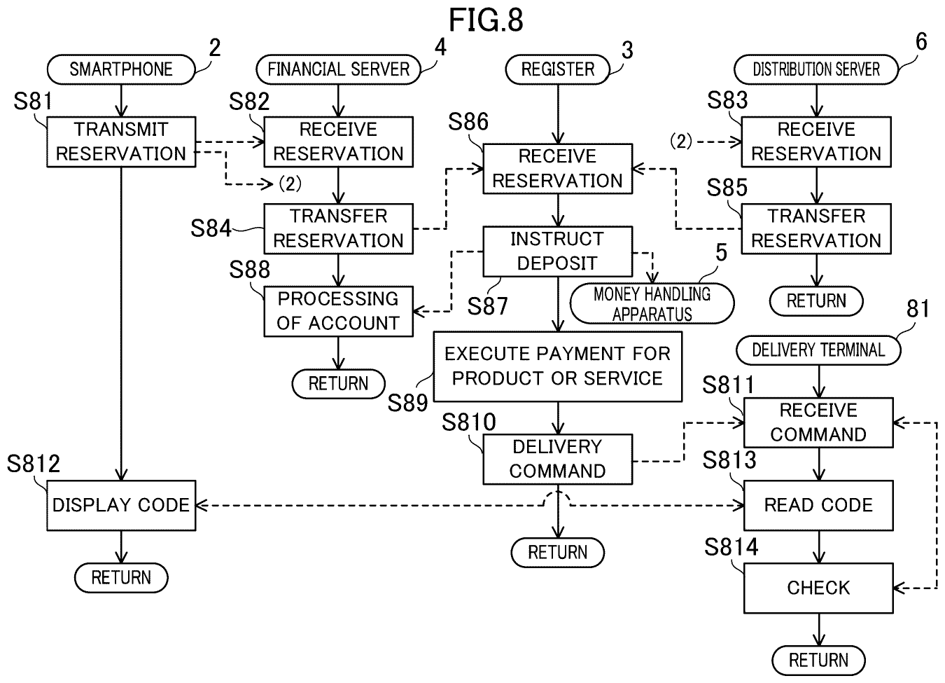

Processing steps of the financial transaction system 100 will be described below with reference to FIGS. 7 and 8. First, the user makes a reservation of a financial transaction and a reservation of a product or service using the smartphone 2 in Step S81. As described above, the reservation of the financial transaction includes at least (1) information on the type of the financial transaction desired by the user, that is, information that the transaction is a withdrawal in this example, (2) the withdrawal amount, and (3) information on the delivery destination of the cash. The reservation of the product or the service includes at least specification of the product that the user plans to purchase or the service that the user wishes to receive at the store 30 and information on the delivery destination of the product or the item derived from the service.

The user may specify the delivery destination of the product or the item derived from the service and the delivery destination of the withdrawn cash as the same delivery destination or different delivery destinations. For example, the delivery destination of the cash may be specified as the user's home, and the delivery destination of the product or the item derived from the service may be specified as other place than the home, for example, a hospital where a relative of the user is hospitalized.

The financial server 4 receives the reservation of the financial transaction from the smartphone 2 in Step S82. The distribution server 6 receives the reservation of the product or the service from the smartphone 2 in Step S83. The financial server 4 transfers the reservation information to the register 3 of the store 30 where the financial transaction is made based on the reservation information in Step S84. The distribution server 6 transfers the reservation information to the register 3 of the store 30 where the user purchases the product or receives the service based on the reservation information in Step S85.

The register 3 of the store 30 receives the reservation from the financial server 4 and the reservation from the distribution server 6 in Step S86, and instructs the money handling apparatus 5 to dispense cash based on the received financial information in Step S87. The register 3 also reports to the financial server 4 that the cash transaction is executed. The financial server 4 records the withdrawal from the user's account corresponding to the cash transaction performed in Step S88.

The register 3 also executes a payment process for the product or the service in Step S89. The payment process is executed based on the operation of the smartphone 2 by the user at the reservation. The distribution server 6 may execute the payment process. Alternatively, a delivery terminal 81 which will be described later may execute the payment process. The product or the item derived from the service is prepared in the store 30. The register 3 may acquire identification information of a staff member who packed the product or item prepared for delivery in response to the payment process in Step S89 and identification information of a staff member who packed the cash dispensed for the withdrawal process in Step S87. The identification information of the staff member may be acquired using the bar code reader 32b.

In the financial transaction system 100, the delivery of the product and the like is performed by an AMR 8 as shown in FIG. 7. The AMR 8 is an example of an autonomous mobile object. The autonomous mobile object is not limited to the AMR 8, and may be a drone capable of autonomous flight. The delivery may be performed by any means other than the autonomous mobile object. A remotely operated mobile object or a delivery person may deliver the product and the like. The AMR 8 is equipped with a delivery terminal 81. The delivery terminal 81 is an example of a third terminal. The delivery terminal 81 may include a storage, a communication unit, a camera, and a controller. When the delivery person delivers the product and the like, the person carries the delivery terminal 81.

When the product and the like to be delivered is loaded on the AMR 8, the register 3 outputs a delivery command to the delivery terminal 81 in Step S810. The delivery command includes information on the reservation and information on the delivery destination. The delivery terminal 81 receives the delivery command from the register 3 in Step S811. Upon receiving the delivery command, the delivery terminal 81 causes the AMR 8 to depart for the delivery destination (see the dashed arrow in FIG. 7).

When the AMR 8 arrives at the delivery destination, the user operates the smartphone 2 to show the code related to the reserved financial transaction on the display of the smartphone 2 (see Step S812). The delivery terminal 81 reads the code on the display with the camera (see Step S813). The delivery terminal 81 checks the read code against the information included in the delivery command in Step S814.

If the code matches the information, the delivery terminal 81 allows the product loaded on the AMR 8 to be passed to the user. The delivery terminal 81 allows the cash related to the financial transaction to be passed to the user. The delivery terminal 81 may execute a payment process when checking the code. When delivery objects (the product and the cash) are to be delivered to different delivery destinations, the product and/or the cash is passed to the user at each delivery destination. When two or more delivery destinations are specified, one of the product or the cash may be passed to the user at one delivery destination.

In the financial transaction system 100, the user may visit the store 30 to make a payment and the financial transaction with the register 3.

In the financial transaction systems 1, 10, and 100 described above, an upper limit may be set on the amount of money handled by the financial transaction.

The register 3 as the second terminal is not limited to the register placed at the store 30.

The functions of the elements disclosed herein may be implemented using circuitry or processing circuitry including general purpose processors, special purpose processors, integrated circuits, application specific integrated circuits (ASICs), conventional circuitry, and/or combinations thereof configured or programmed to perform the disclosed functions. The processor is considered a processing circuit or circuitry because it includes transistors and other circuits therein. The processor may be a programmed processor that executes programs stored in memory. In the present disclosure, circuits, units, or means are hardware that performs or is programmed to perform the functions recited. The hardware may be hardware disclosed in the present specification or other known hardware. When the processor includes hardware as one of circuits, a circuit, a means, or a unit is a combination of hardware and software, and the software is used to constitute the hardware and/or the processor.

What is claimed is:

1. A method of processing a financial transaction, the method comprising:
acquiring, by a second terminal used by a store, first information related to a reservation of a financial transaction accepted by a first terminal;
acquiring, by the second terminal, second information related to a payment for a product or service by a user who reserved the financial transaction; and
performing, by the second terminal, a cash transaction based on the first information on the reservation in a case where a payment process is executed based on the second information.

2. The method of claim 1, wherein the second terminal is connected to a money handling apparatus that handles cash,
the method further comprising:
causing, by the second terminal, the money handling apparatus to handle cash in a case where the cash transaction is performed based on the first information.

3. The method of claim 1, wherein
the second information is related to a payment for a product or service provided by the store.

4. The method of claim 3, wherein the product or an item derived from the service is provided to the user via a locker,
the method further comprising:
the locker being unlocked in conjunction with the execution, by the second terminal, of the payment process based on the second information.

5. The method of claim 1, wherein
the second information is related to a payment for a product or service provided by a second store different from the store.

6. The method of claim 5, wherein the product or an item derived from the service is provided to the user via a locker,
the method further comprising:
the locker being unlocked in conjunction with the execution, by the second terminal, of the payment process based on the second information.

7. The method of claim 1, further comprising:
performing, by the second terminal, the cash transaction based on the first information and the payment process based on the second information individually or collectively.

8. The method of claim 1, further comprising:
accepting, by the first terminal, a reservation of the product or the service in addition to the reservation of the financial transaction; and
creating, by the second terminal, the second information including information on the reservation of the product or the service and information on the payment for the product or the service based on the reservation of the product or the service accepted by the first terminal.

9. The method of claim 8, further comprising:
outputting, by the second terminal, a command related to the delivery of cash withdrawn based on the first information, and the product or an item derived from the service, to a third terminal used for the executing the delivery.

10. The method of claim 9, wherein
the third terminal is carried by a delivery person in charge of the delivery or mounted on an autonomous mobile object in charge of the delivery.

11. The method of claim 9, further comprising:
outputting, by the second terminal, a command including a first delivery destination of the cash and a second delivery destination of the product or the item to the third terminal.

12. The method of claim 11, wherein
the third terminal is carried by a delivery person in charge of the delivery or mounted on an autonomous mobile object in charge of the delivery.

13. The method of claim 1, further comprising:
transmitting, by the first terminal, the first information to a financial server; and
acquiring, by the second terminal, the first information via the financial server.

14. The method of claim 8, wherein the store is a distributor store, the method further comprising:
transmitting, by the first terminal, the first information to the financial server, and the reservation of the product or the service to a distribution server; and
acquiring, by the second terminal, the first information via the financial server, and information on the reservation of the product or the service via the distribution server.

15. The method of claim 14, wherein
the financial server and the distribution server are included in a single server.

16. The method of claim 1, further comprising:
performing, by the second terminal, a withdrawal transaction that is the cash transaction, in conjunction with the payment process.
